(19) United States
(12) Patent Application Publication
(10) Pub. No.: US 2016/0240117 A1
(43) Pub. Date: Aug. 18, 2016

(54) DISPLAY PANEL AND DISPLAY DEVICE

(71) Applicant: SHENZHEN CHINA STAR OPTOELECTRONICS TECHNOLOGY CO., LTD., Guangdong (CN)

(72) Inventor: Xiangyang XU, Shenzhen, Guangdong (CN)

(21) Appl. No.: 14/382,272

(22) PCT Filed: May 26, 2014
(86) PCT No.: PCT/CN2014/078374

§ 371 Date: Aug. 29, 2014

(30) Foreign Application Priority Data
May 22, 2014 (CN) 201410219525.4

(51) Int. Cl. G09G 3/00; G09G 3/36; G09G 3/3225

(52) U.S. Cl. CPC G09G 3/003; G09G 3/3225; G09G 3/3648; G09G 2300/0452; G09G 2320/0613; G09G 2310/08; G09G 2320/08

(57) ABSTRACT

A display panel is disclosed. The display panel has at least two sub-pixel units, the sub-pixel unit has blue sub-pixels, red sub-pixels, and green sub-pixels. The blue sub-pixels are disposed adjacent to each other in the same pixel unit, the red sub-pixels are disposed adjacent to each other in the same pixel unit, and the green sub-pixels are disposed adjacent to each other in the same pixel unit, for automatically switching between 2D and 3D images, so as to smooth the displayed picture.

### FIELD OF THE INVENTION

The present invention relates to the technical field of a display, in particular, a display panel and a display device.

### BACKGROUND OF THE INVENTION

The current mainstream display panel includes a thin film transistor liquid crystal display (TFT-LCD) and an active-matrix organic light-emitting diode display panel (AMOLED). As a new generation display technology, the AMOLED has unique advantages, such as a wider color gamut, faster response time, better brightness, greater perspective, lower power consumption, smaller volume, etc. However, with continuous development of new materials and new technologies, the image quality gap between TFT-LCD and AMOLED is decreasing, and because the AMOLED technology has not yet been refined and the production cost is higher than that of the TFT-LCD, the AMOLED can only be applied to small-size products at present.

Furthermore, the resolution of display panels is also increasing; the maximum display resolution of the current market has reached 3840×2160 (4K×2K) (i.e. High Definition, HD). Due to the limitation of signal sources, HD display panels have not yet been promoted, but with the development of information technology, 4K high-definition signal source is gaining popularity, so that HD display panels will gradually spread into many households. In addition, 3D display devices are expected to grow rapidly.

### SUMMARY OF THE INVENTION

An object of the present invention is to provide a display panel and a display device for automatically switching between 2D and 3D images, as well as to smooth the display picture and reduce production cost.

To solve the above problem, the present invention provides a display panel, the display panel is a liquid crystal panel or an active-matrix organic light-emitting diode display panel; the display panel includes an array substrate; the array substrate comprises data lines, scan lines, and a plurality of pixel units defined by intersecting the data lines and the scan lines; the pixel unit comprises four sub-pixel units, wherein four blue sub-pixels are arranged in a 2×2 matrix configuration, four red sub-pixels are arranged in a 2×2 matrix configuration, four green sub-pixels are arranged in a 2×2 matrix configuration, all sub-pixels in the pixel unit are arranged in a 2×6 matrix configuration.

According to the preferred embodiment of the present invention, when the display panel displays a first 2D image, the first 2D image comprises a plurality of display pixels; each of the sub-pixel units in the pixel unit receives data signals and scan signals of different display pixels.

According to the preferred embodiment of the present invention, when the display panel displays a 3D image, the 3D image comprises a plurality of display pixels; the sub-pixel units constituted by the sub-pixels located in odd columns in the pixel unit receive data signals and the scan signals of left-eye display pixels; the sub-pixel units constituted by the sub-pixels located in even columns in the pixel unit receive data signals and the scan signals of right-eye display pixels.

According to the preferred embodiment of the present invention, when the display panel displays a 3D image, the 3D image comprises a plurality of display pixels; the sub-pixel units constituted by the sub-pixels locating in odd columns in the pixel unit receive data signals and scan signals of right-eye display pixels; the sub-pixel units constituted by the sub-pixels located in even columns in the pixel unit receive data signals and scan signals of left-eye display pixels.

According to the preferred embodiment of the present invention, when the display panel displays a first 2D image, the first 2D image comprises a plurality of display pixels; each of the sub-pixel units in the pixel unit receives a data signal and a signal of the same display pixel.

According to the preferred embodiment of the present invention, the sub-pixel comprises a thin film transistor (TFT); the array substrate further comprises a source-driver chip and a gate-driver chip: the gate-driver chip includes a first gate-driver chip and a second gate-driver chip; the source-driver chip includes a first source-driver chip and a second source-driver chip; wherein the first gate-driver chip is configured to input a scan signal via the scan lines to control terminals of TFT of the sub-pixels located in odd rows in the pixel unit; the second gate-driver chip is configured to input a scan signal via the scan lines to control terminals of TFT of the sub-pixels locating in even rows in the pixel unit; the first source-driver chip is configured to input a data signal via the data lines to input terminals of TFT of the sub-pixels located in odd columns in the pixel unit; the second source-driver chip is configured to input a data signal via the data lines to input terminals of TFT of the sub-pixels located in even columns in the pixel unit.

According to the preferred embodiment of the present invention, the display panel further includes a signal control module comprising: a signal analysis chip which is configured to analyze a resolution and a display mode of the input signal source of the display panel to generate an analysis result; a timing controller which is configured to process the signal source according to the analysis result from the signal analysis chip to obtain the data signals and scan signals, and to transmit the obtained data signals and scan signals to the source-driver chip and the gate-driver chip.

The present invention proposes a display panel comprising an array substrate; the array substrate comprises data lines, scan lines, and a plurality of pixel units defined by intersecting the data lines and the scan lines; the pixel unit comprises at least two sub-pixel units, the sub-pixel unit includes blue sub-pixels, red sub-pixels, and green sub-pixels, the blue sub-pixels are disposed adjacent to each other in the same pixel unit, the red sub-pixels are disposed adjacent to each other in the same pixel unit, the green sub-pixels are disposed adjacent to each other in the same pixel unit.

According to the preferred embodiment of the present invention, the pixel unit comprises four sub-pixel units, wherein four blue sub-pixels are arranged in a 2×2 matrix configuration, four red sub-pixels are arranged in a 2×2 matrix configuration, four green sub-pixels are arranged in a 2×2 matrix configuration, and all sub-pixels in the pixel unit are arranged in a 2×6 matrix configuration.

According to the preferred embodiment of the present invention, when the display panel displays a first 2D image, the first 2D image comprises a plurality of display pixels; each of the sub-pixel units in the pixel unit receives data signals and scan signals of different display pixels.

According to the preferred embodiment of the present invention, when the display panel displays a 3D image, the 3D image comprises a plurality of display pixels; the sub-pixel units constituted by the sub-pixels located in odd columns in the pixel unit receive data signals and scan signals of left-eye display pixels; the sub-pixel units constituted by the sub-pixels located in even columns in the pixel unit receive data signals and scan signals of right-eye display pixels.

According to the preferred embodiment of the present invention, when the display panel displays a 3D image, the 3D image comprises a plurality of display pixels; the sub-pixel units constituted by the sub-pixels located in odd columns in the pixel unit receive data signals and scan signals of right-eye display pixels; the sub-pixel units constituted by the sub-pixels located in even columns in the pixel unit receive data signals and scan signals of left-eye display pixels.

According to the preferred embodiment of the present invention, when the display panel displays a second 2D image, the second 2D image comprises a plurality of display pixels; each of the sub-pixel units in the pixel unit receives a data signal and a scan signal of the same display pixel.

According to the preferred embodiment of the present invention, the sub-pixel comprises a thin film transistor (TFT); the array substrate further comprises a source-driver chip and a gate-driver chip: the gate-driver chip includes a first gate-driver chip and a second gate-driver chip; the source-driver chip includes a first source-driver chip and a second source-driver chip; wherein the first gate-driver chip is configured to input a scan signal via the scan lines to control terminals of TFT of the sub-pixels locating in odd rows in the pixel unit; the second gate-driver chip is configured to input a scan signal via the scan lines to control terminals of TFT of the sub-pixels located in even rows in the pixel unit; the first source-driver chip is configured to input a data signal via the data lines to input terminals of TFT of the sub-pixels located in odd columns in the pixel unit; the second source-driver chip is configured to input a data signal via the data lines to input terminals of TFT of the sub-pixels located in even columns in the pixel unit.

According to the preferred embodiment of the present invention, the display panel further includes a signal control module comprising: a signal analysis chip which is configured to analyze a resolution and a display mode of the input signal source of the display panel to generate an analysis result; a timing controller which is configured to process the signal source according to the analysis result from the signal analysis chip to obtain the data signals and scan signals, and to transmit the obtained data signals and scan signals to the source-driver chip and the gate-driver chip.

According to the preferred embodiment of the present invention, the display panel is a liquid crystal display panel or an active-matrix organic light-emitting diode display panel.

Another objective of the present invention is to provide a display device comprising a display panel. The display panel includes an array substrate; the array substrate comprises data lines, scan lines, and a plurality of pixel units defined by intersecting the data lines and the scan lines; the pixel unit comprises at least two sub-pixel units, the sub-pixel unit includes blue sub-pixels, red sub-pixels, and green sub-pixels. The blue sub-pixels are disposed adjacent to each other in the same pixel unit, the red sub-pixels are disposed adjacent to each other in the same pixel unit, and the green sub-pixels are disposed adjacent to each other in the same pixel unit.

The present invention provides an array substrate with different arranged sub-pixels in a pixel unit for automatically switching between 2D and 3D images, as well as to smooth the display picture; and also adopts two regular gate-driver chips and two regular source-driver chips to achieve the complicated driving processes, thereby reducing the production cost.

### BRIEF DESCRIPTION OF THE DRAWINGS

FIG. 1 is a schematic diagram of a pixel unit according to a first preferred embodiment of the present invention;

FIG. 2 is a schematic diagram of a pixel unit according to a second preferred embodiment of the present invention;

FIG. 3 is a schematic diagram of a pixel unit according to a third preferred embodiment of the present invention;

FIG. 4 is a schematic diagram of a driving circuit according to the first preferred embodiment to the third preferred embodiment of the present invention; and

FIG. 5 is a workflow and a schematic diagram of a signal control module according to the fourth preferred embodiment of the present invention.

### DETAILED DESCRIPTION OF THE PREFERRED EMBODIMENTS

The following descriptions of the respective embodiments are specific embodiments capable of being implemented as illustrations of the present invention, with reference to the appended figures. The terms up, down, front, rear, left, right, interior, exterior, side, etcetera are merely directions referring to the appended figures. Therefore, such directions are employed for explaining and understanding the present invention, but are not limitations thereto. In the drawings, similar structures are represented by the same symbols.

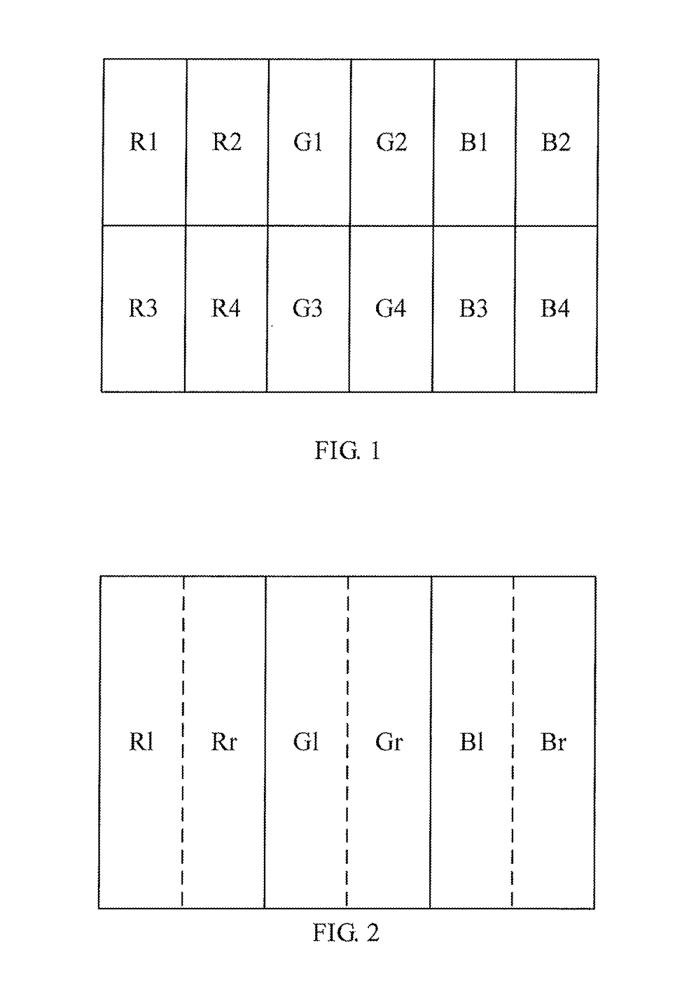

FIG. 1 is a schematic diagram of a pixel unit according to a first preferred embodiment of the present invention.

The display panel of the present invention includes an array substrate which comprising data lines, scan lines, and a plurality of pixel units defined by intersecting the data lines and the scan lines. The pixel unit comprises: a red pixel, a green pixel, and a blue pixel (for example, RGB). The pixel unit can also include a yellow pixel or a white pixel. The present invention only takes a pixel unit arranged in the order of red pixel, green pixel, and blue pixel (RGB) for an example, but it is not limited thereto. For instance, the pixel unit may further include other arrangements like: a blue pixel, a red pixel, and a green pixel (BRG) arranged in sequence.

As shown in FIG. 1, the red pixel is divided into four red sub-pixels R1, R2, R3, and R4, the red sub-pixels are arranged in a 2×2 matrix (the red sub-pixel R1 is arranged at a zero row and a zero column of the 2×2 matrix of the red pixel, the red sub-pixel R2 is arranged at the zero row and a first column of the 2×2 matrix of the red pixel, the red sub-pixel R3 is arranged at a first row and the zero column of the 2×2 matrix of the red pixel, the red sub-pixel R4 is arranged at the first row and the first column of the 2×2 matrix of the red pixel).

The green pixel is divided into four green sub-pixels G1, G2, G3, and G4, the green sub-pixels are arranged in a 2×2 matrix (a matrix of the four green sub-pixels is the same as the four red sub-pixels as described above, and will not be enumerated herein).

The blue pixel is divided into four blue sub-pixels B1, B2, B3, and B4, the four blue sub-pixels are arranged in a 2×2 matrix (a matrix configuration of the four blue sub-pixels is the same as the four red sub-pixels as described above, and will not be enumerated herein).

Of course, the above matrix configurations can also be arranged in other matrix configurations (for example, the red sub-pixel R1 is arranged at the zero row and the zero column of the 2×2 matrix of the red pixel, the red sub-pixel R2 is arranged at the first row and the zero column of the 2×2 matrix of the red pixel, the red sub-pixel R3 is arranged at the zero column and the first column of the 2×2 matrix of the red pixel, the red sub-pixel R4 is arranged at the first row and the first column of the 2×2 matrix of the red pixel), which are within the scope of the present invention, and will not to be enumerated herein.

The sub-pixel units R1, G1, B1 constitutes a first sub-pixel unit, the sub-pixel units R2, G2, B2 constitutes a second sub-pixel unit, the sub-pixel units R3, G3, B3 constitutes a third sub-pixel unit, the sub-pixel units R4, G4, B4 constitutes a fourth sub-pixel unit, all sub-pixels of the pixel unit are arranged in a 2×6 matrix. The sub-pixels of the pixel unit can also be arranged in other matrix configurations (such as 6×2 matrix), which are within the scope of the present invention, and will not be enumerated herein.

In the present invention, when the display panel displays a first 2D image, the first 2D image comprises a plurality of display pixels; the first 2D image is a high-definition 2D image (such as 4K image); each of the sub-pixel units in the pixel unit receives data signals and scan signals of different display pixels.

Since in the conventional technology, when displaying a high-definition 2D image, the sub-pixels which are located in odd rows of the pixel unit are arranged in a sequence of R1G1B1R2G2B2, such that different colored sub-pixels are disposed adjacent to each other. When displaying the high-definition image, the display picture is not smooth enough under a situation that human eye is not perceived.

However, in the present invention, the sub-pixels which are located in odd rows of the pixel unit are arranged in a sequence of, for example R1R2G1G2B1B2, such that the same colored sub-pixels are disposed adjacent to each other in a final display picture (which means that the red sub-pixels are disposed adjacent to each other in the same pixel unit, the green sub-pixels are disposed adjacent to each other in the same pixel unit, and the blue sub-pixels are disposed adjacent to each other in the same pixel unit). Compared with the conventional technology in which different colored sub-pixels are disposed adjacent to each other, by adopting the above configuration the display picture can more smoothly be displayed as a high-definition 2d image.

In the conventional technology, the array substrate comprises a gate-driver chip and a source-driver chip, the gate-driver chip is configured to input a scan signal via scan lines to control terminals of TFTs of each pixel in the pixel unit, the gate-driver chip is configured to transmit a data signal via data lines to input terminals of TFTs of each pixel in the pixel unit. When the gate-driver chip transmits the scan signal to the pixels of first row, the source-driver chip transmits the data signal to the pixels of the first row. When the gate-driver chip inputs the scan signal to the pixels of second row, the source-driver chip inputs the data signal to the pixels of second row.

The preferred embodiment further comprises a driving circuit shown in FIG. 4. Each of the sub-pixels comprises a thin film transistor (TFT). The array substrate further comprises a source-driver chip and a gate-driver chip (not shown in FIG. 4). The gate-driver chip includes a first gate-driver chip 11 and a second gate-driver chip 12. The source-driver chip includes a first source-driver chip 21 and a second source-driver chip 22. The first gate-driver chip 11 is configured to input a scan signal via the scan lines to control terminals of TFTs of the sub-pixels located in odd rows (such as R1R2G1G2B1B2) in the pixel unit. The second gate-driver chip 12 is configured to input a scan signal via the scan lines to control terminals of TFTs of the sub-pixels located in even rows (such as R3R4G3G4B3B4) in the pixel unit. The first source-driver chip 21 is configured to input a data signal via the data lines to input terminals of TFTs of the sub-pixels located in odd columns (such as R1G1B1R3G3B3) in the pixel unit; the second source-driver chip 22 is configured to input a data signal via the data lines to input terminals of TFTs of the sub-pixels located in even columns (such as R2G2B2R4G4B4) in the pixel unit.

Only a single gate-driver chip and a single source-driver chip are provided in the conventional technology. In order to display a high-definition 2D image, a more complicated process is needed. The functional requirements of the single gate-driver chip and the single source-driver chip are higher, and the structural design of which is more complicated. By contrast, the present invention only adopts two regular gate-driver chips and two regular source-driver chips to achieve the more complicated processes, thereby reduced the production cost.

The display panel is a liquid crystal panel or an active-matrix organic light-emitting diode display panel.

FIG. 2 is a schematic diagram of a pixel unit according to a second preferred embodiment of the present invention.

The display panel of the present invention includes an array substrate comprising data lines, scan lines, and a plurality of pixel units defined by intersecting the data lines and the scan lines. The pixel unit comprises: a red pixel, a green pixel, a blue pixel (for example, RGB). The pixel unit can also include a yellow pixel or a white pixel. The present invention only takes the pixel unit arranged in an order of red pixel, green pixel, and blue pixel (RGB) for an example, but it is not limited to, e.g. the pixel unit may further include other arrangements like: blue pixel, red pixel, and green pixel (BRG).

As shown in FIG. 1, the red pixel is divided into four red sub-pixels R1, R2, R3, and R4, the red sub-pixels are arranged in a 2×2 matrix configuration (the red sub-pixel R1 is arranged in a zero row and a zero column of a 2×2 matrix of the red pixel, the red sub-pixel R2 is arranged at the zero row and a first column of the 2×2 matrix of the red pixel, the red sub-pixel R3 is arranged at a first row and the zero column of a 2×2 matrix of the red pixel, the red sub-pixel R4 is arranged at the first row and the first column of a 2×2 matrix of the red pixel).

The green pixel is divided into four green sub-pixels G1, G2, G3, and G4, the green sub-pixels are arranged in a 2×2 matrix (a matrix configuration of the four green sub-pixels is the same as the four red sub-pixels as described above, and will not be enumerated herein).

The blue pixel is divided into four blue sub-pixels B1, B2, B3, and B4, the four blue sub-pixels are arranged in a 2×2 matrix (a matrix configuration of the four blue sub-pixels is the same as the four red sub-pixels as described above, and will not be enumerated herein).

The above matrix configuration can also be arranged into other matrix configurations (for example, the red sub-pixel R1 is arranged at the zero row and the zero column of the 2×2 matrix of the red pixel, the red sub-pixel R2 is arranged at the first row and the zero column of the 2×2 matrix of the red pixel, the red sub-pixel R3 is arranged at the zero column and the first column of the 2×2 matrix of the red pixel, the red sub-pixel R4 is arranged at the first row and the first column of the 2×2 matrix of the red pixel), which are within the scope of the present invention, and will not be enumerated herein.

R1G1B1 constitutes a first sub-pixel unit, R2G2B2 constitutes a second sub-pixel unit, R3G3B3 constitutes a third sub-pixel unit, R4G4B4 constitutes a fourth sub-pixel unit, all of the sub-pixels of the pixel unit are arranged in a 2×6 matrix. The sub-pixels of the pixel unit can also be arranged into other matrix configurations (such as a 6×2 matrix), which are within the scope of the present invention, and will not be enumerated herein.

In the present invention, when the display panel displays a 3D image, the 3D image comprises a plurality of display pixels. Each of the sub-pixels in the sub-pixel unit are disposed in the same position of the corresponding pixel matrices (for example, in a first sub-pixel unit R1G1B1, a red sub-pixel R1 is arranged at a zero row and a zero column of a 2×2 matrix of the red pixel, a green sub-pixel G1 is arranged at a zero row and a zero column of a 2×2 matrix of the green pixel, a blue sub-pixel B1 is arranged at a zero column and a zero column of a 2×2 matrix of the blue pixel).

The sub-pixel units (such as R1G1B1 and R3G3B3) constituted by the sub-pixels located in odd columns in the pixel unit receive the data signals and scan signals of left-eye display pixels or right-eye display pixels, the sub-pixel units (such as R2G2B2 and R4G4B4) constituted by the sub-pixels locating in even columns in the pixel unit receive the data signals and scan signals of right-eye display pixels or right-eye display pixels.

When R1G1B1 and R3G3B3 receive the data signals and the scan signals of the left-eye display images, R2G2B2 and R4G4B4 receive the data signals and the scan signals of the right-eye display images. In this case, the equivalent structure diagram of the pixel unit is illustrated in FIG. 2, wherein the red sub-pixels R1 and R3 are equivalent to R1 (a red left-eye pixel), the green sub-pixels G1 and G3 are equivalent to G1 (a green left-eye pixel), and the blue sub-pixels B1 and B3 are equivalent to B1 (a blue left-eye pixel).

The red sub-pixels R2 and R4 are equivalent to Rr (a red right-eye pixel), the green sub-pixels G2 and G4 are equivalent to Gr (a green right-eye pixel), the blue sub-pixels B2 and B4 are equivalent to Br (a blue right-eye pixel).

When the R1G1B1 and R3G3B3 receive the data signals and scan signals of the right-eye display images, the R2G2B2 and R4G4B4 receive the data signals and scan signals of the left-eye display images. In this case, an equivalent structure diagram of the pixel unit is obtained by swapping the left-eye pixels and right-eye pixels of all of the colors in FIG. 2, and will not be enumerated herein.

Since in the conventional technology, when displaying a 3D image, the sub-pixels which are located in the odd rows of the pixel unit are arranged in a sequence of R1G1B1R2G2B2, such that different colored sub-pixels are disposed adjacent to each other. When displaying the 3D image, the display picture is not smooth enough under a situation that human eye is not perceived.

However, in the present invention, the sub-pixels which are located in the odd rows of the pixel unit are arranged in a sequence of, for example R1R2G1G2B1B2, such that the same colored sub-pixels are disposed adjacent to each other in a final display picture (which means that the red sub-pixels are disposed adjacent to each other in the same pixel unit. The green sub-pixels are disposed adjacent to each other in the same pixel unit, and the blue sub-pixels are disposed adjacent to each other in the same pixel unit).

Compared with the conventional technology in which different colored sub-pixels are disposed adjacent to each other, by adopting the above structure, the display picture can more smoothly be displayed as a 3d image.

In the conventional technology, the array substrate comprises a gate-driver chip and a source-driver chip. The gate-driver chip is configured to input a scan signal via scan lines to control terminals of TFT of each pixel in the pixel unit, the gate-driver chip is configured to input a data signal via data lines to the input terminals of TFT of each pixel in the pixel unit. When the gate-driver chip inputs the scan signal to the pixels of first row, the source-driver chip inputs the data signal to the pixels of the first row. When the gate-driver chip inputs the scan signal to the pixels of second row, the source-driver chip inputs the data signal to the pixels of second row.

The preferred embodiment further comprises a driving circuit of which the structure is shown in FIG. 4. Each of the sub-pixels comprises a thin film transistor (TFT); the array substrate further comprises a source-driver chip and a gate-driver chip, the gate-driver chip includes a first gate-driver chip 11 and a second gate-driver chip 12. The source-driver chip includes a first source-driver chip 21 and a second source-driver chip 22. The first gate-driver chip 11 is configured to input a scan signal via the scan lines to control terminals of TFT of the sub-pixels located in odd rows (such as R1R2G1G2B1B2) in the pixel unit; the second gate-driver chip 12 is configured to input a scan signal via the scan lines to control terminals of TFT of the sub-pixels located in even rows (such as R3R4G3G4B3B4) in the pixel unit; the first gate-driver chip 11 and the second gate-driver chip 12 of the present invention simultaneously input the same scan signal to the sub-pixels located in even rows and odd rows, respectively.

The first source-driver chip 21 is configured to input a data signal via the data lines to input terminals of TFT of the sub-pixels located in odd columns (such as R1G1B1R3G3B3) in the pixel unit (the data signals are the data signals of the left-eye display pixels or the right-eye display pixels).

The second source-driver chip 22 is configured to input a data signal via the data lines to input terminals of TFT of the sub-pixels located in even columns (such as R2G2B2R4G4B4) in the pixel unit (the data signals are the data signals of the left-eye display pixels or the right-eye display pixels). When the first source-driver chip 21 inputs a data signal of the left-eye display pixels, the second source-driver chip 22 inputs a data signal of the right-eye display pixels; when the first source-driver chip 21 inputs a data signal of the right-eye display pixels, the second source-driver chip 22 inputs a data signal of the left-eye display pixels.

Only a single gate-driver chip and a single source-driver chip are provided in the conventional technology in order to display a 3D image, and a more complicated process is needed. The functional requirement of the single gate-driver chip and the single source-driver chip are higher, and the structural design of which is more complicated. However, the present invention adopts only two regular gate-driver chips and two regular source-driver chips to achieve the more complicated processes, thereby reduced the production cost.

The display panel is a liquid crystal display panel or an active-matrix organic light-emitting diode display panel.

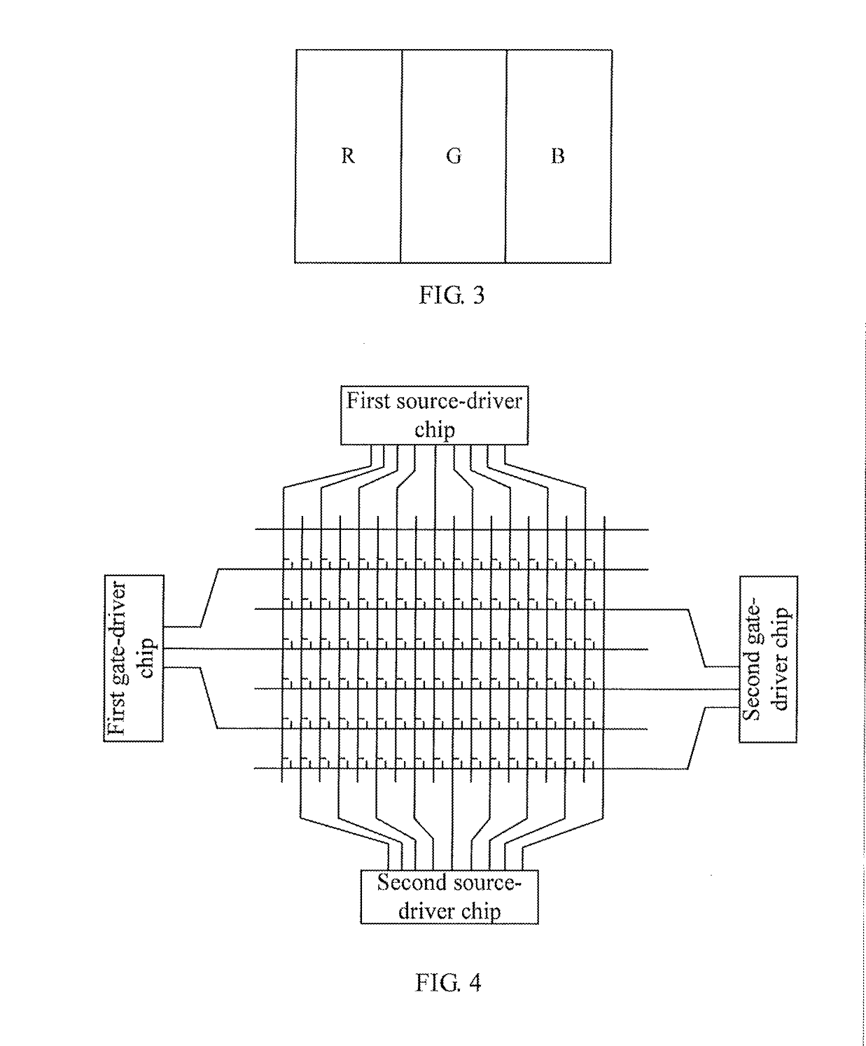

FIG. 3 is a schematic diagram of a pixel unit according to a third preferred embodiment of the present invention.

The display panel of the present invention includes an array substrate comprising data lines, scan lines, and a plurality of pixel units defined by intersecting the data lines and the scan lines, the pixel unit comprises: a red pixel, a green pixel, a blue pixel (for example, RGB); of course, the pixel unit can also include a yellow pixel or a white pixel. The present invention only takes a pixel unit arranged in the order of red pixel, green pixel, and blue pixel (RGB) for an example, but it is not limited to, e.g. the pixel unit may further include other arrangements like: blue pixel, red pixel, and green pixel (BRG).

As shown in FIG. 1, the red pixel is divided into four red sub-pixels R1, R2, R3, and R4, the red sub-pixels are arranged in a 2×2 matrix configuration (the red sub-pixel R1 is arranged in a zero row and a zero column of the 2×2 matrix of the red pixel, the red sub-pixel R2 is arranged in the zero row and a first column of the 2×2 matrix of the red pixel, the red sub-pixel R3 is arranged in a first row and the zero column of the 2×2 matrix of the red pixel, the red sub-pixel R4 is arranged in the first row and the first column of the 2×2 matrix of the red pixel).

The green pixel is divided into four green sub-pixels G1, G2, G3, and G4, the green sub-pixels are arranged in a 2×2 matrix configuration (a matrix configuration of the four green sub-pixels is the same as the four red sub-pixels as described above, and will not be enumerated herein).

The blue pixel is divided into four blue sub-pixels B1, B2, B3, and B4, the four blue sub-pixels are arranged in a 2×2 matrix configuration (a matrix configuration of the four blue sub-pixels is the same as the four red sub-pixels as described above, and will not be enumerated herein).

Of course, the above matrix configurations can also be arranged into other matrix configurations (for example, the red sub-pixel R1 is arranged in the zero row and the zero column of the 2×2 matrix of the red pixel, the red sub-pixel R2 is arranged in the first row and the zero column of the 2×2 matrix of the red pixel, the red sub-pixel R3 is arranged in the zero column and the first column of the 2×2 matrix of the red pixel, the red sub-pixel R4 is arranged in the first row and the first column of the 2×2 matrix of the red pixel), which are within the scope of the present invention, and will not be enumerated herein.

Wherein R1G1B1 constitutes a first sub-pixel unit, R2G2B2 constitutes a second sub-pixel unit, R3G3B3 constitutes a third sub-pixel unit, R4G4B4 constitutes a fourth sub-pixel unit, all sub-pixels of the pixel unit are arranged in a 2×6 matrix configuration, the sub-pixels of the pixel unit can also be arranged into other matrix configurations (such as 6×2), which are within the scope of the present invention, and will not be enumerated herein.

In the present embodiment, when the display panel displays a second 2D image, the second 2D image comprises a plurality of display pixels; the second 2D image is a low-definition 2D image; each of the sub-pixel units in the pixel unit receives a data signal and a scan signal of the same display pixel. In this case, the equivalent diagram of the pixel unit is shown in FIG. 3, where all of the red sub-pixels R1, R2, R3, R4 are equivalent to R (a red pixel), all of the green sub-pixels G1, G2, G3, G4 are equivalent to G (a green pixel), all of the blue sub-pixels B1, B2, B3, B4 are equivalent to B (a blue pixel).

In the conventional technology, when displaying the low-definition 2D image, the sub-pixels which are located in the odd rows of the pixel unit are arranged in a sequence of R1G1B1R2G2B2, such that different colored sub-pixels are disposed adjacent to each other. However, in the present invention, the sub-pixels which are located in the odd rows of the pixel unit are arranged in a sequence of, for example R1R2G1G2B1B2, such that the same colored sub-pixels are disposed adjacent to each other in a final display picture (which means that the red sub-pixels are disposed adjacent to each other in the same pixel unit, the green sub-pixels are disposed adjacent to each other in the same pixel unit, and the blue sub-pixels are disposed adjacent to each other in the same pixel unit).

Compared with the conventional technology in which different colored sub-pixels are disposed adjacent to each other, by adopting the above configuration, an equivalent display effect as the conventional technology can be achieved when displaying the low-definition 2D image.

In the conventional technology, the array substrate comprises a gate-driver chip and a source-driver chip. The gate-driver chip is configured to input a scan signal via scan lines to the control terminals of TFTs of each pixel in the pixel unit, the gate-driver chip is configured to input a data signal via data lines to the input terminals of TFTs of each pixel in the pixel unit. When the gate-driver chip inputs the scan signal to the pixels of a first row, the source-driver chip inputs the data signal to the pixels of the first row. When the gate-driver chip inputs the scan signal to the pixels of a second row, the source-driver chip inputs the data signal to the pixels of second row.

The preferred embodiment further comprises a driving circuit, which the structure is shown in FIG. 4, each of the sub-pixels comprises a thin film transistor (TFT); the array substrate further comprises a source-driver chip and a gate-driver chip: the gate-driver chip includes a first gate-driver chip 11 and a second gate-driver chip 12; the source-driver chip includes a first source-driver chip 21 and a second source-driver chip 22. The first gate-driver chip 11 is configured to input a scan signal via the scan lines to control terminals of TFTs of the sub-pixels located in odd rows (such as R1R2G1G2B1B2) in the pixel unit; the second gate-driver chip 12 is configured to input a scan signal via the scan lines to control terminals of TFTs of the sub-pixels located in even rows (such as R3R4G3G4B3B4) in the pixel unit. the first gate-driver chip 11 and the second gate-driver chip 12 of the present invention simultaneously input the same scan signal to the sub-pixels located in even rows and odd rows, respectively.

The first source-driver chip 21 is configured to input a data signal via the data lines to the input terminals of TFT of the sub-pixels located in the odd columns (such as R1G1B1R3G3B3) in the pixel unit; the second source-driver chip 22 is configured to input a data signal via the data lines to the input terminals of TFT of the sub-pixels located in the even columns (such as R2G2B2R4G4B4) in the pixel unit.

The first source-driver chip 21 and the second source-driver chip 22 of the present invention simultaneously input the same data signal to the sub-pixels located in even columns and odd columns, respectively.

While the conventional technology only provides a gate-driver chip and a source-driver chip, the present invention adopts two regular gate-driver chips and two regular source-driver chips to achieve the same display effect as the conventional technology when displaying the low-definition 2D images.

The display panel is a liquid crystal panel or an active-matrix organic light-emitting diode display panel.

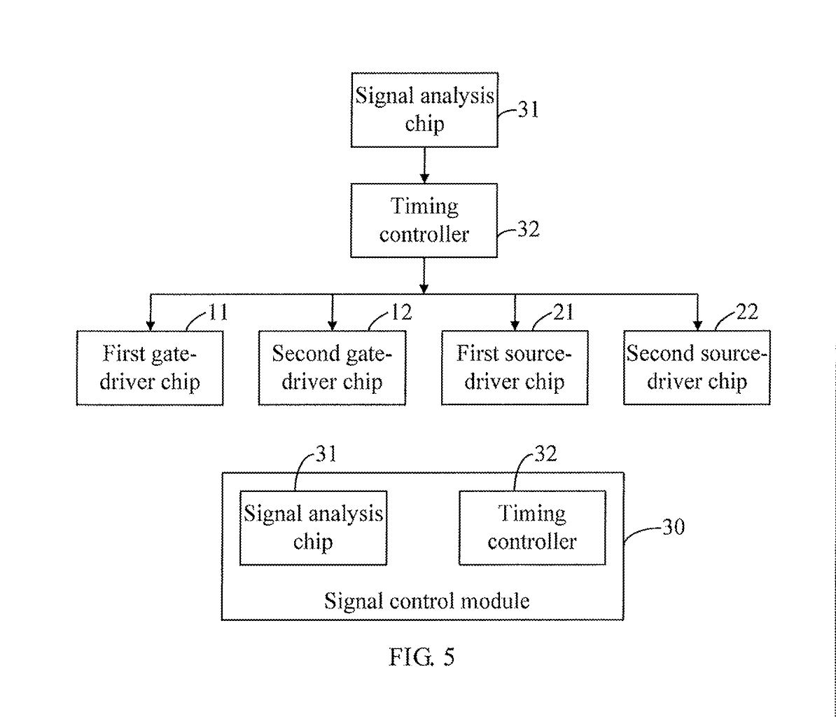

FIG. 5 is a workflow and a schematic diagram of a signal control module according to the fourth preferred embodiment of the present invention.

As shown in FIG. 5, the display panel further includes a signal control module 30 which comprises a signal analysis chip 31 and a timing controller 32; the signal analysis chip 31 is configured to analyze a resolution and a display mode of the input signal source of the display panel to generate an analysis result. The display mode is a 3D mode or a 2D mode; the timing controller 32 is configured to process the signal source according to the analysis result from the signal analysis chip to obtain the data signals and scan signals, and to transmit the obtained data signals and scan signals to the source-driver chip and the gate-driver chip.

This means that when analyzing the input image of the display panel, the input image includes the high-definition 2D image, the 3D image, and the low-definition 2D image, wherein the input image comprises a plurality of display pixels.

For example, when the input image is analyzed as a high-definition 2D image by the signal analysis chip 31, the timing controller 32 is configured to process the input image to obtain the scan signal and data signal of the display pixels of the high-definition 2D image, and input the obtained scan signal to the first gate-driver chip 11 and the first source-driver chip 12 as described in the first preferred embodiment, as well as to input the obtained data signal to the first gate-driver chip 21 and the first source-driver chip 21 and the second source-driver chip 22, so as to display the high-definition 2D image.

For example, when the input image is analyzed as a 3D image by the signal analysis chip 31, the timing controller 32 is configured to process the input image to obtain the scan signal and data signal of the display pixels of the 3D image, and input the obtained scan signal to the first gate-driver chip 11 and the first source-driver chip 12 as described in the second preferred embodiment, as well as to input the obtained data signal to the first gate-driver chip 21 and the first source-driver chip 21 and the second source-driver chip 22, so as to display the 3D image.

For example, when the input image is analyzed as a low-definition 2D image by the signal analysis chip 31, the timing controller 32 is configured to process the input image to obtain the scan signal and data signal of the display pixels of the low-definition 2D image, and input the obtained scan signal to the first gate-driver chip 11 and the first source-driver chip 12 as described in the third preferred embodiment, as well as to input the obtained data signal to the first gate-driver chip 21 and the first source-driver chip 21 and the second source-driver chip 22, so as to display the low-definition 2D image.

Refer to the preferred embodiments 1 to 3 of the present invention for the specific driving methods by using the above mentioned driver chips, the details are not described herein.

The present invention provides a signal control module, which is able to analyze a resolution and a display mode of the input image (such as the high-definition 2D image, the low-definition 2D image, and the 3D image), also is configured to process the image according to the result confirmed by analysis to obtain the data signal and the scan signal of the driving circuit of the image described above, for automatically switching between 2D and 3D images, and reducing the production cost to provide a convenient living.

The present invention further includes a display device which comprises a display panel. The display panel includes an array substrate. The array substrate comprises data lines, scan lines, and a plurality of pixel units defined by intersecting the data lines and the scan lines. The pixel unit comprises two or more sub-pixel units. The sub-pixel unit includes blue sub-pixels, red sub-pixels, and green sub-pixels, the blue sub-pixels of the same pixel unit are disposed adjacent to each other, the red sub-pixels of the same pixel unit are disposed adjacent to each other, the green sub-pixels of the same pixel unit are disposed adjacent to each other.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A display panel, which is a liquid crystal display panel or an active-matrix organic light-emitting diode display panel, comprising:
an array substrate comprising data lines, scan lines, and a plurality of pixel units defined by intersecting the data lines and the scan lines;
each pixel unit comprising four sub-pixel units, wherein four blue sub-pixels are arranged in a 2×2 matrix, four red sub-pixels are arranged in a 2×2 matrix, four green sub-pixels are arranged in a 2×2 matrix, and the four red sub-pixels, the four blue sub-pixels and the four green sub-pixels in the pixel unit are arranged in a 2×6 matrix.

2. The display panel as claimed in claim 1, wherein upon the condition that the display panel displays a first 2D image, the first 2D image comprises a plurality of display pixels;
each of the sub-pixel units in the pixel unit receives data signals and scan signals of different display pixels.

3. The display panel as claimed in claim 1, wherein upon the condition that the display panel displays a 3D image, the 3D image comprises a plurality of display pixels;
the sub-pixels located in odd columns in the pixel unit receive data signals and the scan signals of left-eye display pixels;
the sub-pixels located in even columns in the pixel unit receive data signals and the scan signals of right-eye display pixels.

4. The display panel as claimed in claim 1, wherein upon the condition that the display panel displays a 3D image, the 3D image comprises a plurality of display pixels;
the sub-pixels located in odd columns in the pixel unit receive data signals and scan signals of right-eye display pixels;
the sub-pixels located in even columns in the pixel unit receive data signals and scan signals of left-eye display pixels.

5. The display panel as claimed in claim 1, wherein upon the condition that the display panel displays a first 2D image, the first 2D image comprises a plurality of display pixels;
each of the sub-pixel units in the pixel unit receives a data signal and the a signal of the same display pixel.

6. The display panel as claimed in claim 2, wherein the sub-pixel comprises a thin film transistor (TFT);
the array substrate further comprises a source-driver chip and a gate-driver chip:
the gate-driver chip includes a first gate-driver chip and a second gate-driver chip;
the source-driver chip includes a first source-driver chip and a second source-driver chip;
wherein the first gate-driver chip is configured to transmit a scan signal via the scan lines to control terminals of TFTs of the sub-pixels located in odd rows in the pixel unit;
the second gate-driver chip is configured to transmit a scan signal via the scan lines to control terminals of TFTs of the sub-pixels located in even rows in the pixel unit;
the first source-driver chip is configured to transmit a data signal via the data lines to input terminals of TFTs of the sub-pixels located in odd columns in the pixel unit;
the second source-driver chip is configured to transmit a data signal via the data lines to input terminals of TFT of the sub-pixels located in even columns in the pixel unit.

7. The display panel as claimed in claim 6, wherein the display panel further includes a signal control module comprising:
a signal analysis chip configured to analyze a magnitude and a display mode of the input signal source of the display panel to generate an analysis result; and
a timing controller configured to process the signal source according to the analysis result from the signal analysis chip to obtain the data signals and the scan signals, and to transmit the obtained data signals and scan signals to the source-driver chip and the gate-driver chip.

8. A display panel comprising an array substrate;
the array substrate comprising data lines, scan lines, and a plurality of pixel units defined by intersecting the data lines and the scan lines;
each pixel unit comprising two or more sub-pixel units, the sub-pixel unit including blue sub-pixels, red sub-pixels, and green sub-pixels, the blue sub-pixels being disposed adjacent to each other in the same pixel unit, the red sub-pixels being disposed adjacent to each other in the same pixel unit, and the green sub-pixels being disposed adjacent to each other in the same pixel unit.

9. The display panel as claimed in claim 8, wherein the pixel unit comprises four sub-pixel units, wherein four blue sub-pixels are arranged in a 2×2 matrix, four red sub-pixels are arranged in a 2×2 matrix, four green sub-pixels are arranged in the 2×2 matrix, and the four red sub-pixels, the four blue sub-pixels and the four green sub-pixels in the pixel unit are arranged in a 2×6 matrix.

10. The display panel as claimed in claim 9, wherein when the display panel displays a first 2D image, the first 2D image comprises a plurality of display pixels;
each of the sub-pixel units in the pixel unit receives data signals and scan signals of different display pixels.

11. The display panel as claimed in claim 9, wherein when the display panel displays a 3D image, the 3D image comprises a plurality of display pixels;
the sub-pixels located in odd columns in the pixel unit receive data signals and scan signals of left-eye display pixels;
the sub-pixels located in even columns in the pixel unit receive data signals and scan signals of right-eye display pixels.

12. The display panel as claimed in claim 9, wherein when the display panel displays a 3D image, the 3D image comprises a plurality of display pixels;
the sub-pixels located in odd columns in the pixel unit receive data signals and scan signals of right-eye display pixels;
the sub-pixels located in even columns in the pixel unit receive data signals and scan signals of left-eye display pixels.

13. The display panel as claimed in claim 9, wherein when the display panel displays a second 2D image, the second 2D image comprises a plurality of display pixels;
each of the sub-pixel units in the pixel unit receives a data signal and a scan signal of the same display pixel.

14. The display panel as claimed in claim 10, wherein the sub-pixel comprises a thin film transistor (TFT);
the array substrate further comprises a source-driver chip and a gate-driver chip:
the gate-driver chip includes a first gate-driver chip and a second gate-driver chip;
the source-driver chip includes a first source-driver chip and a second source-driver chip;
wherein the first gate-driver chip is configured to transmit a scan signal via the scan lines to control terminals of TFT of the sub-pixels located in odd rows in the pixel unit;
the second gate-driver chip is configured to transmit a scan signal via the scan lines to control terminals of TFT of the sub-pixels located in even rows in the pixel unit;
the first source-driver chip is configured to transmit a data signal via the data lines to input terminals of TFT of the sub-pixels located in odd columns in the pixel unit;
the second source-driver chip is configured to transmit a data signal via the data lines to input terminals of TFT of the sub-pixels located in even columns in the pixel unit.

15. The display panel as claimed in claim 11, wherein the sub-pixel comprises a thin film transistor (TFT);
the array substrate further includes a source driver chip and a gate driver chip:
the gate-driver chip includes a first gate-driver chip and a second gate-driver chip;
the source-driver chip includes a first source-driver chip and a second source-driver chip;
wherein the first gate-driver chip is configured to transmit a scan signal via the scan lines to control terminals of TFT of the sub-pixels located in odd rows in the pixel unit;
the second gate-driver chip is configured to transmit a scan signal via the scan lines to control terminals of TFT of the sub-pixels located in even rows in the pixel unit;
the first source-driver chip is configured to transmit a data signal via the data lines to input terminals of TFT of the sub-pixels located in odd columns in the pixel unit;
the second source-driver chip is configured to transmit a data signal via the data lines to input terminals of TFT of the sub-pixels located in even columns in the pixel unit.

16. The display panel as claimed in claim 12, wherein the sub-pixel comprises a thin film transistor (TFT);
the array substrate further includes a source driver chip and a gate driver chip:
the gate-driver chip includes a first gate-driver chip and a second gate-driver chip;
the source-driver chip includes a first source-driver chip and a second source-driver chip;
wherein the first gate-driver chip is configured to transmit a scan signal via the scan lines to control terminals of TFT of the sub-pixels located in odd rows in the pixel unit;
the second gate-driver chip is configured to transmit a scan signal via the scan lines to control terminals of TFT of the sub-pixels located in even rows in the pixel unit;
the first source-driver chip is configured to input a data signal via the data lines to input terminals of TFT of the sub-pixels located in odd columns in the pixel unit;
the second source-driver chip is configured to input a data signal via the data lines to input terminals of TFT of the sub-pixels located in even columns in the pixel unit.

17. The display panel as claimed in claim 13, wherein the sub-pixel comprises a thin film transistor (TFT);
the array substrate further includes a source driver chip and a gate driver chip:
the gate-driver chip includes a first gate-driver chip and a second gate-driver chip;
the source-driver chip includes a first source-driver chip and a second source-driver chip;
wherein the first gate-driver chip is configured to input a scan signal via the scan lines to control terminals of TFT of the sub-pixels located in odd rows in the pixel unit;
the second gate-driver chip is configured to input a scan signal via the scan lines to control terminals of TFT of the sub-pixels located in even rows in the pixel unit;
the first source-driver chip is configured to input a data signal via the data lines to input terminals of TFT of the sub-pixels located in odd columns in the pixel unit;
the second source-driver chip is configured to input a data signal via the data lines to input terminals of TFT of the sub-pixels located in even columns in the pixel unit.

18. The display panel as claimed in claim 14, the display panel further includes a signal control module comprising:
a signal analysis chip configured to analyze a magnitude and a display mode of the input signal source of the display panel to generate an analysis result;
a timing controller configured to process the signal source according to the analysis result from the signal analysis chip to obtain the data signals and scan signals, and to transmit the obtained data signals and scan signals to the source-driver chip and the gate-driver chip.

19. The display panel as claimed in claim 8 being a liquid crystal display panel or an active-matrix organic light-emitting diode display panel.

20. A display device comprising a display panel;
the display panel including an array substrate;
the array substrate comprising data lines, scan lines, and a plurality of pixel units defined by intersecting the data lines and the scan lines;
the pixel unit comprising at least two sub-pixel units, the sub-pixel unit including blue sub-pixels, red sub-pixels and green sub-pixels, the blue sub-pixels disposed adjacent to each other in the same pixel unit, the red sub-pixels disposed adjacent to each other in the same pixel unit, the green sub-pixels disposed adjacent to each other in the same pixel unit.
